(19) United States
(12) Patent Application Publication
(10) Pub. No.: US 2014/0143691 A1
(43) Pub. Date: May 22, 2014

(54) USER INTERFACE GENERATING APPARATUS AND ASSOCIATED METHOD

(71) Applicant: MStar Semiconductor, Inc., Hsinchu Hsien (TW)

(72) Inventor: Hung-Chi Huang, Taichung City (TW)

(73) Assignee: MStar Semiconductor, Inc., Hsinchu Hsien (TW)

(21) Appl. No.: 14/042,803

(22) Filed: Oct. 1, 2013

(30) Foreign Application Priority Data
Nov. 22, 2012 (TW) 101143751

(51) Int. Cl. G06F 3/0481

(52) U.S. Cl. CPC G06F 3/04817
USPC 715/762

(57) ABSTRACT

A user interface apparatus and associated method are configured to estimate a distance to a user and display a graphic user interface according to the distance, so as to adaptively adjust a display image of the user interface according to the distance.

This application claims the benefit of Taiwan application Serial No. 101143751, filed Nov. 22, 2012, the subject matter of which is incorporated herein by reference.

### BACKGROUND OF THE INVENTION

1. Field of the Invention

The invention relates in general to a user interface generating apparatus and associated method applied to a display system, and more particularly to a user interface generating apparatus and associated method capable of adjusting a user interface according to a distance to a user.

2. Description of the Related Art

Display systems, and more particularly television systems, are one of the most prominent information sources in modern information society, and are an essential part of the modern daily life. A display system, in addition to presenting dynamic or still image contents, also displays a graphic user interface, e.g., an on-screen display (OSD). For example, a user interface may include texts, numerals, symbols or graphics to display an operation status and operation parameters of the display system, such as a signal source (a channel number, or a number or name of an input terminal), an image format of image contents, the number of sound channels, a language (English or other languages), a volume, brightness, contrast and color temperatures. A user interface may also display a menu and control options to allow a user to control operations of the display system, and to set operation parameters and an operation mode of the display system. Further, a user interface may also include subtitles or lyrics synchronous to image contents.

Further, as a contemporary display system can be employed as a display terminal of various electronic products, a user interface of the display system may also serve as a human-machine interface (HMI) of electronic products. For example, the display system may include a processor system and a network interface for implementing functions of a computer, a video phone, a video conference system and/or a security monitoring host; the interface may correspondingly serve as the HMI of the computer, and includes a cursor, icons, menus, control options and windows.

However, in the prior art, a user interface is incapable of initiating adjustments and thus falls short in enhancing user-friendliness of the user interface.

### SUMMARY OF THE INVENTION

According to an objective of the present invention, a user interface generating apparatus for a display system is provided. The user interface generating apparatus comprises a distance measurement module, for estimating a distance to a user and accordingly providing distance information; and an adjustment module, for providing an interface layout according to the distance information, and prompting the display system to display an associated user interface according to the interface layout.

According to another objective of the present invention, a user interface generating method for a display system is provided. The user interface generating method comprises: estimating a distance between a user and the display system and accordingly providing distance information; providing an interface layout according to the distance information; and prompting the display system to display an associated user interface according to the interface layout.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a user interface generating apparatus for a display system according to an embodiment of the present invention.

FIGS. 2 and 3 are schematic diagrams of the user interface generating apparatus according to application embodiments.

FIG. 4 is a flowchart according to an embodiment of the present invention, and is applicable to the user interface generating apparatus in FIG. 1.

### DETAILED DESCRIPTION OF THE INVENTION

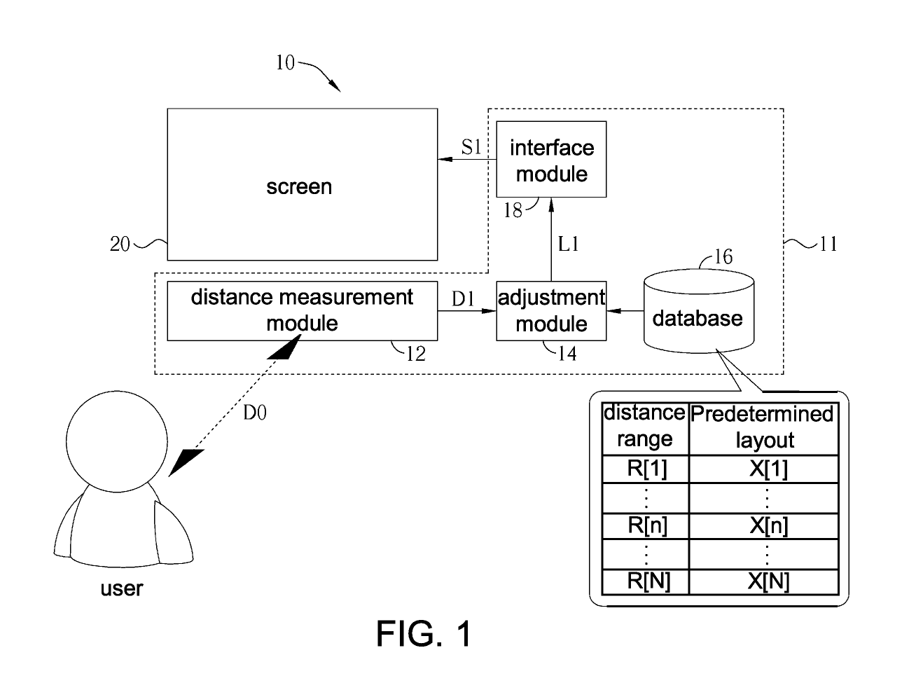

FIG. 1 shows a schematic diagram of a user interface generating apparatus for a display system according to an embodiment of the present invention. To illustrate the present invention, the display system of the present invention is exemplified by a television system 10. The television system 10 may comprise a user interface generating apparatus 11 and a screen 20. The user interface generating apparatus 11 comprises a distance measurement module 12 and an adjustment module 14. The distance measurement module 12 estimates a distance D0 between the television system 10 and a user/users, and accordingly provides distance information D1. The adjustment module 14, coupled to the distance measurement module 12, provides an interface layout according to the distance information D1 for prompting the television system 10 to accordingly display an associated user interface. The user interface generating apparatus 11 may further comprise a database 16 and an interface module 18. The database 16, coupled to the adjustment module 14, provides a plurality of predetermined layouts X[1], . . . , X[n] to X[N], which are respectively associated with a plurality of distance ranges R[1], . . . , R[n] to R[N]. According to the distance information D1, the adjustment module 14 selects, from the distance ranges R[1] to R[N], the distance range R[n] satisfying the distance D0, and utilizes the predetermined layout X[n] associated with the selected distance range R[n] as an interface layout L1. The interface module 18, coupled to the screen 20 and the adjustment module 14, provides associated interface information S1 according to the interface layout L1, e.g., graphic contents of a user interface. For example, the layout interface L1 may include a font size setting of subtitles; the interface module 18 may access text contents of the subtitles, and integrates an expected graphic appearance of the subtitle texts to the interface information S1 according to the font size set by the interface layout L1. The screen 20 displays dynamic and/or still image contents, and may superimpose the user interface of the interface information S1 onto the image contents to jointly display the image contents with the user interface. In one embodiment, for example, the screen 20 is a television screen. Alternatively, the screen 20 may be a liquid-crystal display (LCD) panel or a curtain onto which an image can be projected.

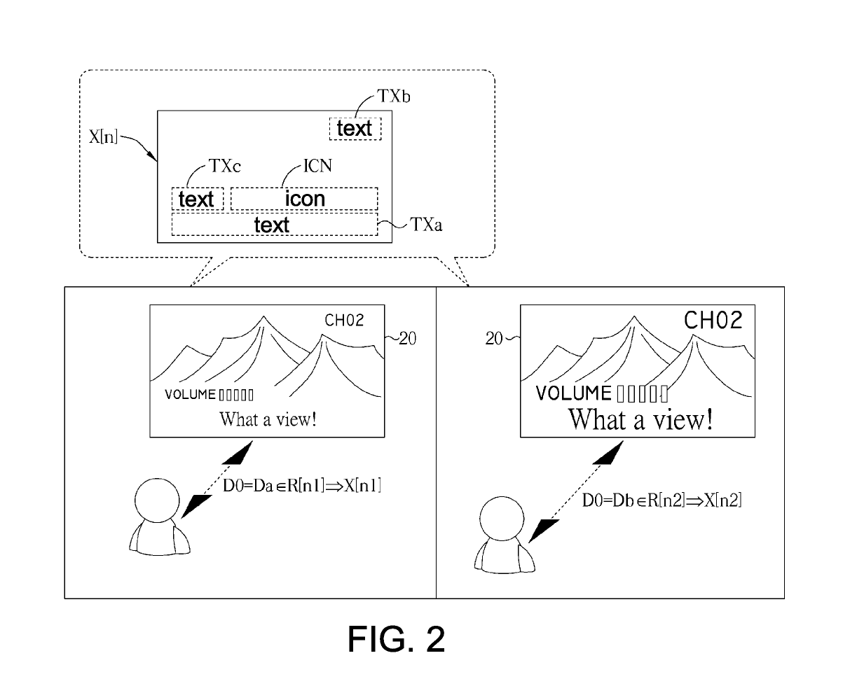

In continuation of the embodiment in FIG. 1, FIG. 2 shows a user interface generating apparatus for a television system according to an embodiment of the present invention. As shown in FIG. 2, the predetermined layout X[n] may include texts TXa, TXb and TXc, and an icon ICN. For example, the text Txa comprises subtitles, the text TXb and the icon ICN respectively display different operation parameters of the television system 10, and the text TXc illustrates the icon ICN. Each predetermined layout X[n] may include font sizes and arrangement positions of the texts TXa to TXc, and an icon size and an arrangement position of the icon ICN. For example, in two different predetermined layouts X[n1] and X[n2], the texts TXa to TXc may have different font sizes and arrangement positions, and the icon ICN may also have different icon sizes and arrangement positions. For example, in the predetermined layout X[n1], the texts TXa to TXc and the icon ICN may have smaller sizes, and the distance range R[n1] associated with the predetermined layout X[n1] is shorter. In contrast, in the predetermined layout X[n2], the texts TXa to TXc and the icon ICN may have larger sizes, and the distance range R[n2] associated with the predetermined layout X[n2] may be longer

When the distance D0 between the user and the television system 10 is equal to a shorter distance Da and corresponds to the distance range R[n1], the adjustment module 14 (in FIG. 1) utilizes the predetermined layout X[n1] as the interface layout L1, and the interface module 18 displays a user interface having smaller texts and icon on the screen 20 according to the interface layout L1. When the distance D0 between the user and the television system 10 is equal to a longer distance Db and corresponds to the distance range R[n2], the interface module 18 displays a same user interface having the same contents but a different graphic appearance, with, e.g., larger texts and icon on the screen 20, as shown in FIG. 2. Thus, the interface can be dynamically adjusted according to the change in the distance D0, so as to ensure that a user can perceive a clear user interface regardless of the distance to the user. In one embodiment, the image contents (i.e., contents from a signal source) displayed by the screen 20 may stay unchanged although the distance D0 may change.

In another embodiment, the predetermined layout X[n1] and X[n2] may set smaller and larger font sizes for only the text TXa, while keeping sizes of the texts TXb and TXc and the icon ICN the same. Therefore, when the distance D0 changes from the distance range R[n1] to the distance range R[n2], only the text TXa changes its font size according to the change in the distance D0, whereas the sizes of the texts TXb and TXc and the icon ICN stay the same. Further, the predetermined layouts X[n1] and X[n2] may also set different properties for texts and/or icons, including font type, font pattern (e.g., bold or italic), font color, font transparency and/or icon size, color and transparency. For example, in the predetermined layouts X[n1] ] and X[n2], different font types and/or font patterns may be set for the text TXa, so that the text TXa can be displayed by a font type and/or font pattern that appears more clearly when the user is located at a farther distance. In one embodiment, the predetermined layouts X[n1] ] and X[n2] may set different arrangements and change-row properties for the text TXa. More specifically, the text TXa may be displayed in one row using a smaller font size when the distance is shorter, and may be display in two rows using a larger font size when the distance is longer. In an alternative embodiment, the predetermined layouts X[n1] ] and X[n2] may set different transparencies and colors (and/or different brightness and saturation levels) for the icon ICN, so as to display the icon ICN with a lower transparency, a greater brightness level and/or more saturated and more contrasted colors when the distance is longer.

In one embodiment of the present invention, the texts of the user interface may be vector fonts, of which font sizes can be easily changed. And/Alternatively, certain texts and/or icons of the user interface may be bitmaps, and the interface module 18 may up-scale or down-scale by incorporating techniques such as anti-aliasing and display scaled bitmap texts and/or icons satisfying sizes specified in the interface layout. And/Alternatively, the database 16 may store bitmap texts and/or icons respectively pre-designed for different distance ranges. For example, bitmap icons pre-designed for a smaller distance range may be small-sized icons having smaller numbers of pixels, and bitmap icons pre-designed for a larger distance range may be large-sized icons having larger numbers of pixels. And/Alternatively, the database 16 may store bitmap texts and/or icons pre-designed for a plurality of distance ranges, and bitmap texts and/or icons required by other distance ranges can be calculated from the bitmap texts and/or icons of the distance ranges. For example, the database 16 may first record bitmap texts and/or icons for distance ranges R[n0] and R[n2]. When the distance detected by the distance measurement module 12 falls in the distance range R[n1] that is between the distance ranges R[n0] and R[n2], the bitmap icon corresponding to the distance range R[n1] may be obtained through interpolation according to the bitmap icons of the distance ranges R[n0] and R[n2].

In an embodiment of the present invention, a part or all of the texts and/or icons of the user interface may be obtained through rendering a two-dimensional (2D) or a three-dimensional (3D) model (e.g., a polygonal model). Therefore, by changing rendering settings (e.g., a focal length, amplification ratio and/or field of depth), the sizes and/or icon appearances of such texts and/or icons can be modified.

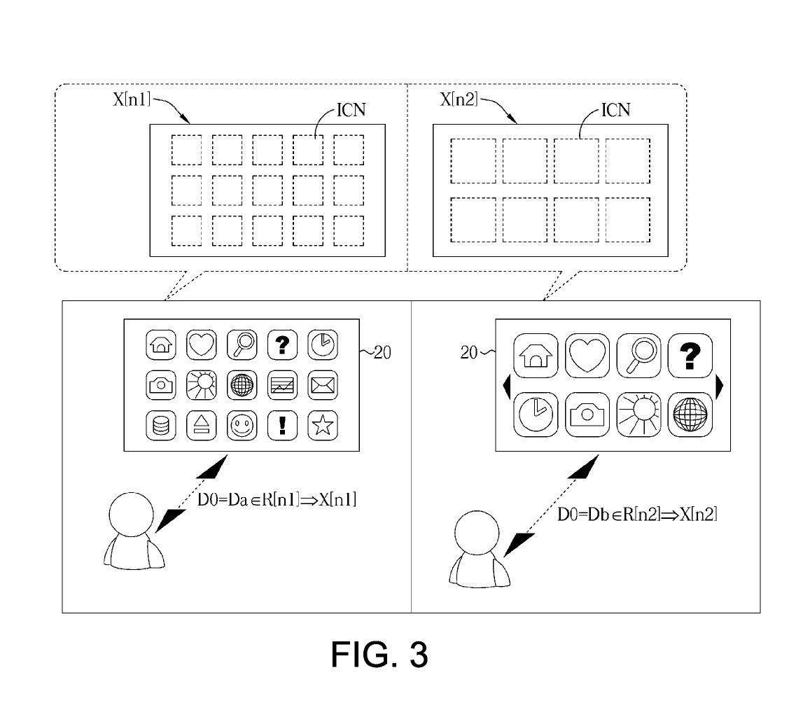

In continuation of the embodiment in FIG. 1, FIG. 3 shows a user interface generating apparatus for a television system according to another embodiment of the present invention. As shown in FIG. 3, the predetermined layouts X[n1] and X[n2] may have a plurality of icons ICN, which may have different sizes and different arrangements (arrangement positions). For example, the predetermined layout X[n]1 has a smaller corresponding range R[n1] and icons ICN in a smaller size, with a larger number of icons arranged within one page. In contrast, the predetermined layout X[n2] is associated with a larger distance range R[n2] and employs icons in a larger size, and thus with a smaller number of icons arranged within one page. Therefore, when the distance D0 between the user and the television system 10 is equal to a short distance Da that falls within the distance range R[n1], the adjustment module 14 (in FIG.1) utilizes the predetermined layout X[n1] as the interface layout L1, and the interface module 18 displays a user interface having smaller icons on the screen 20 according to the interface layout L1. When the distance D0 between the user and the television system 10 is equal to a longer distance Db that falls within the distance range R[n2], the interface module 18 displays a user interface having larger icons on the screen 20 according to the predetermined layout X[n2], as shown in FIG. 3. Further, the user is allowed to access other non-displayed icons through appropriate change controls.

In one application embodiment of the present invention, each predetermined layout X[n] may include a window of a sub-image. As such, in addition to displaying image contents from a first signal source as a background main image, the screen 20 is also capable of displaying image contents from a second signal source in a foreground image window. In different predetermined layouts X[n], sizes and/or positions of the sub-image window may be different.

Again referring to FIG. 1, in one embodiment of the present invention, to implement the function of the distance measurement module 12 and to estimate the distance D0 between the user and the television system 10, identical cameras (not shown) at two or more positions at the television system 10 may be disposed to capture shots of the user, so as to determine the distance to the user according to parallax images of the two cameras. When there are multiple users, the distance D0 may be determined according to a nearest or a furthest user, or the distance D0 may be determined according to a statistical value (e.g., an average) of distances to the multiple users. In one embodiment, the distance measurement module 12 may be integrated with a face recognition function for determining a location of the user to accordingly determine the distance D0.

In one embodiment, the distance measurement module 12 may combine a function of characteristic matching (e.g., face recognition) to compare whether characteristics of the user matches one or more predetermined characteristics of a host user. When one or more user characteristics match one or more users, the user(s) matching the characteristics, but not other users that do not match the characteristics, is/are utilized for determining the distance D0. For example, for a household television system, characteristics of the elderly (and/or the young) are predetermined as host characteristics, such that the user interface of the television system may adaptively change according to the distance to the elderly (and/or the young).

In one embodiment, the distance measurement module 12 may combine a motion detection function, and thus determines the distance D0 according to a moving user when a motion of the user is detected.

In other embodiments of distance measurement, the distance measurement module 12 may measure the distance D0 by incorporating positioning techniques such as sound wave, ultrasonic wave, shock wave, electromagnetic wave, laser and infrared techniques. And/Alternatively, the television system 10 may comprise a host device of the screen 20 and a remote controller (not shown), and determine (or assist in determining) the distance D0 between the user and the television system 10 according to the distance between the remote controller and the host device.

In an application embodiment of the present invention, when the distance D0 detected by the distance measurement module 12 gets excessively long (e.g., longer than a first threshold), and/or the distance measurement module 12 detects (identifies) that the television system 10 is currently not watched by any user, the adjustment module 12 may prompt the television system 10 to automatically deactivate a part or the entire user interface, e.g., deactivating the subtitles. In one application embodiment, when the distance measurement module 12 detects that the distance D0 is too short (e.g., shorter than a second threshold), the adjustment module 14 may prompt the television system 10 to display an all-black image, an alert message and/or an alert graphic/icon, so as to warn the user to keep an appropriate distance from the television system 10. The predetermined layouts X[n] in the database 16 and the associated distance ranges R[n] may be pre-defined by a manufacturer, and may be modified, defined, added or deleted by the user.

For example, the distance range R[1] may be “shorter than 1 meter”, and the corresponding predetermined layout X[1] may set the font size of the subtitles to 18 units (e.g., pixels); the distance range R[2] may be “1 to 2 meters”, and the predetermined layout X[2] may set the font size of the subtitles to 20 units; the distance range R[3] may be “2 to 3 meters”, and the predetermined layout X[3] may set the font size of the subtitles to 22 units; the distance range R[4] may be “greater than 3 meters”, and the predetermined layout X[4] may set the font size of the subtitles to 24 units. Thus, when the distance D0 is 2.2 meters, the distance D0 satisfies the distance range R[3], and so the predetermined layout X[3] is selected as the interface layout L1, and the subtitles displayed by the screen 20 are in a font of 22 units. The user may modify upper and lower limits of the distance range R[4] such that the distance range R[4] becomes “3 to 3.5 meters”, and add one more set of distance range R[5] and predetermined layout X[5]. For example, the distance range R[5] may be “greater than 3.5 meters”, and the predetermined layout L[5] may set the font size of the subtitles to 26 units.

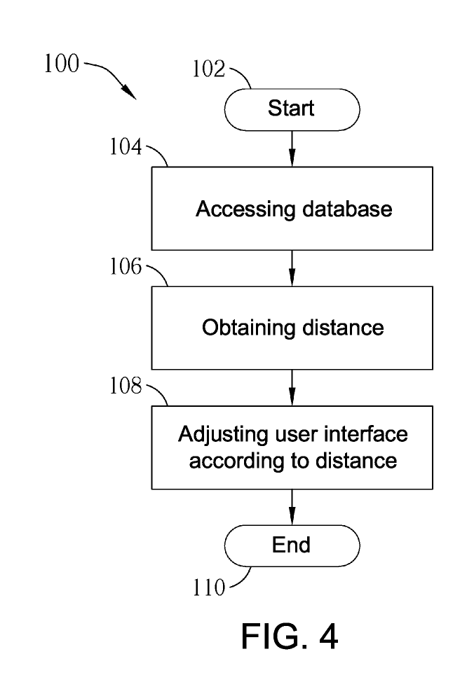

FIG. 4 shows a flowchart according to an embodiment of the present invention. The process in FIG. 4 is applicable to the television system 10 for automatic and adaptive adjustments of the user interface 11 in FIG. 1 according to a distance to a user. The process 100 comprises the steps below.

In step 102, the process 100 starts. For example, the user may select whether to allow the user interface generating apparatus 11 to automatically adjust the user interface according to the user distance. The process 100 begins if yes, or else the process 100 does not begin and the user interface generating apparatus 11 does not modify the user interface with reference to the user distance. And/Alternatively, the user interface generating apparatus 11 may also automatically start the process 100 after being booted and activated.

In step 104, the database 16 is obtained. For example, the database 16 may be stored in a non-volatile memory (not shown) in the user interface generating apparatus 11. After the process 100 begins, data in the database 16 may be loaded from the non-volatile memory to a volatile memory (e.g., a dynamic random access memory (DRAM), or a static random access memory (SRAM), not shown) that can be quickly accessed. After obtaining the data of the database 16, a plurality of predetermined layouts X[1] to X[N] respectively associated with the distance ranges R[1] to R[N] can be provided.

In step 106, the distance measurement module 12 estimates (detects) the distance D0 between the user and the television system 10 to accordingly provide the distance information D1.

In step 108, an adjustment step is performed. According to the distance information D1, from the distance ranges R[1] to R[N], the distance range R[n] satisfying the distance D0 is selected, and the predetermined layout X[n] associated with the selected distance range R[n] is utilized as the interface layout L1. Through operations of the interface module 18, the user interface generating apparatus 11 is able to display the user interface associated with the interface layout L1 on the screen 20.

In step 110, the process 100 ends.

The user interface generating apparatus 11 may periodically repeat the process 100 to dynamically adjust the graphic image presented by the user interface in response to a change in the user distance D0. And/Alternatively, the user interface generating apparatus 11 may be integrated with a motion detection function, and activate the process 100 once a motion of the user is detected.

The television system 10 in FIG. 1 is an example for explaining the embodiments, and may be any electronic device having a display function, such as a desktop computer, an all-in-one computer, a tablet computer, a touch control computer, a laptop computer, a mobile phone, a multimedia player, a digital camera, a camcorder, a navigation device, a game console, a video phone, a video conference system, and a security monitoring host. The modules in the user interface generating apparatus 11 may be implemented by hardware, software, and/or firmware. For example, the distance measurement module 12 may be jointly implemented by distance measuring hardware (e.g., an optical module) and distance calculating software or firmware; the adjustment module 14 may be implemented by software or firmware codes. In one embodiment, the distance measurement module 12 and the screen 20 may be in different devices, i.e., the distance measurement module 12 may be externally connected to a host device of the screen 20.

In conclusion, compared to a conventional user interface where a layout is fixed, the present invention is capable of dynamically, adaptively and automatically adjust a display image of a user interface according to a distance to a user, so as to provide a more friendly and intuitive user interface satisfying user requirements.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A user interface generating apparatus, for a display system, comprising:
a distance measurement module configured to estimate a distance to a user and accordingly provide distance information; and
an adjustment module configured to provide an interface layout according to the distance information for the display system to display an associated user interface according to the interface layout.

2. The user interface generating apparatus according to claim 1, wherein the adjustment module provides different interface layouts for different distance information for the display system to display different user interfaces.

3. The user interface generating apparatus according to claim 1, further comprising:
an interface module configured to provide associated interface information according to the interface layout for the display system to display the associated user interface according to the interface information.

4. The user interface generating apparatus according to claim 1, further comprising:
a database configured to provide a plurality of predetermined layouts;
wherein the adjustment module selects one of the predetermined layouts as the interface layout according to the distance information.

5. The user interface generating apparatus according to claim 4, wherein the database associates a plurality of distance ranges to the predetermined layouts, and the adjustment module selects one of the distance ranges according to the distance information, and utilizes the predetermined layout, associated with the selected distance range, as the interface layout.

6. The user interface generating apparatus according to claim 4, wherein each of the predetermined layouts comprises a font size, and two of the predetermined layouts comprise different font sizes.

7. The user interface generating apparatus according to claim 4, wherein each of the predetermined layouts comprises an icon size, and two of the predetermined layouts comprise different icon sizes.

8. The user interface generating apparatus according to claim 4, wherein each of the predetermined layouts comprises an icon arrangement, and two of the predetermined layouts comprise different icon arrangements.

9. The user interface generating apparatus according to claim 1, wherein the user interface comprises text, and the adjustment module changes a font size of the text in the interface layout in response to the different distance information.

10. The user interface generating apparatus according to claim 1, wherein the user interface comprises at least one icon, and the adjustment module changes a size of the at least one icon in the interface layout in response to the different distance information.

11. The user interface generating apparatus according to claim 1, wherein the user interface comprises at least one icon, and the adjustment module changes an arrangement position of the at least one icon in the interface layout in response to the different distance information.

12. A user interface generating method, for a display system, comprising:
estimating a distance between a user and the display system, and accordingly providing distance information;
providing an interface layout according to the distance information; and
prompting the display system to display an associated user interface according to the interface layout.

13. The user interface generating method according to claim 12, wherein the step of providing the interface layout according to the distance information provides a different interface layout in response to different distance information for the display system to display a different user interface.

14. The user interface generating method according to claim 12, further comprising:
providing a plurality of predetermined layouts associated with a plurality of distance ranges, respectively;
wherein the step of providing the interface layout according to the distance information comprises: selecting one of the distance ranges according to the distance information, and the predetermined layout associated with the selected distance range is utilized as the interface layout.

15. The user interface generating method according to claim 14, wherein each of the predetermined layouts comprises a font size, and two of the predetermined layouts comprise different font sizes.

16. The user interface generating method according to claim 14, wherein each of the predetermined layouts comprises an icon size, and two of the predetermined layouts comprise different icon sizes.

17. The user interface generating method according to claim 14, wherein each of the predetermined layouts comprises an icon arrangement, and two of the predetermined layouts comprise different icon arrangements.

18. The user interface generating method according to claim 12, wherein the user interface comprises text, and the adjustment step changes a font size of the text in the interface layout in response to the different distance information.

19. The user interface generating method according to claim 12, wherein the user interface comprises at least one icon, and the adjustment step changes a size of the at least one icon in the interface layout in response to the different distance information.

20. The user interface generating method according to claim 12, wherein the user interface comprises at least one icon, and the adjustment step changes an arrangement position of the at least one icon in the interface layout in response to the different distance information.
